(19) United States
(12) Patent Application Publication
(10) Pub. No.: US 2021/0134539 A1
(43) Pub. Date: May 6, 2021

(54) Device And Method For Actuating Mechanical Switching Means

(71) Applicant: PIETER VAN WEENEN & CO. GMBH THE HOUSE OF INNOVATION, Waldkirch (DE)

(72) Inventor: Tobias Krebs, Gutach (DE)

(21) Appl. No.: 16/084,163

(22) PCT Filed: Mar. 12, 2017
(86) PCT No.: PCT/EP2017/000327

§ 371 Date: Dec. 11, 2020

(51) Int. Cl. H01H 3/24; A24F 40/40; H01H 13/14

(52) U.S. Cl. CPC H01H 3/24; H01H 2221/02; H01H 13/14; A24F 40/40

(57) ABSTRACT

Devices and method for actuating a switch device (SM) by means of an elastic actuating element with a non-actuating shape 4 without actuating the switch device (SM) and an actuating shape 6 for actuating the switch device (SM).

The present invention relates to the field of mechanical buttons and switches and in particular devices and methods for their operation.

### BACKGROUND OF THE INVENTION

Mechanical buttons and switches are usually designed to be operated by a person, usually by a finger or hand, but also by foot. However, it may be necessary to operate mechanical pushbuttons and switches by technical means, for example during functional tests of the pushbutton/switch and/or tests of a device with the pushbutton/switch.

An example of this is so-called e-cigarettes. There are e-cigarettes where the vaporization process is started (button pressed by the smoker/user) and ended (button not pressed by the smoker/user) by means of a button (also called fire button). As with conventional cigarettes, e-cigarettes are also subjected to automated tests, for example, to determine substances released via the mouthpiece when used. For the e-cigarettes with push-button, it is necessary to be able to operate the push-button by a technical means.

### OBJECT

The present invention is based on the object of providing a solution for the simple and inexpensive actuation of a button or switch.

### BRIEF DESCRIPTION OF THE INVENTION

This object is solved by devices and procedures according to the independent requirements. The dependent claims describe preferred embodiments.

### SHORT DESCRIPTION OF THE DRAWINGS

In the following, forms of execution of the present invention are described on the basis of the drawings.

FIGS. 1 and 2 show cross-sectional views of an embodiment with an actuating element,

FIGS. 3 and 4 show cross-sectional views of an embodiment with an actuating element,

FIG. 5 shows a cross-sectional view of an embodiment with two actuators,

FIG. 6 shows a cross-sectional view of an embodiment with two actuators,

FIGS. 7 and 8 show cross-sectional views of an embodiment with an actuating element arranged in a receptacle with a receptacle cavity,

FIG. 9 shows a cross-sectional view of an embodiment with an actuating element arranged in a receptacle with a receptacle cavity, and

FIGS. 10 and 11 an e-cigarette button actuator.

### DESCRIPTION OF PREFERRED EMBODIMENTS

In the following, the invention will be explained in more detail on the basis of embodiments represented in the figures, whereby in the figures at least substantially functionally identical elements have the same reference signs. Furthermore, embodiments made for different embodiments also apply to all other embodiments, unless otherwise stated.

In the following, buttons, switches and the like will be referred to collectively as switch devices.

One basic idea is to actuate a switch device by means of an elastic and pneumatically and/or hydraulically deformable actuating element.

The actuator may have a non-actuating shape in which the actuator does not actuate the switch device and an actuating shape in which the actuator actuates the switch device. In its non-actuating shape, the actuating element may be spaced from the switch device or contact the switch device only so that switch device is not actuated. In its actuating shape, the actuating element contacts the switch device—if this was not already the case—and exerts a force on the switch device which causes the switch device to be actuated.

The non-actuating shape of the actuating element can be achieved by not applying pneumatic and/or hydraulic pressure to the actuating element so that the switch device does not contact the switch device at all, or by applying pneumatic and/or hydraulic pressure so that the switch device contacts the actuating element only in such a way that no force is applied to the switch device which leads to actuation of the switch device.

The actuating shape of the actuating element can be achieved by applying (more) pneumatic and/or hydraulic pressure to the confirmation element so that the switching medium—if this is not already the case—is contacted and a force is applied to the switching medium which results in actuation of the switching medium.

The actuating element can be arranged in a receptacle, which can, for example, have the shape of an annular groove, a space designed to accommodate a spherical actuating element or an elongated groove.

In the non-actuating shape, the actuating element may be completely located in the receptacle (in particular, so that no part of the actuating element extends out of the receptacle) or so that it partially extends out of the receptacle. In both cases, the actuating element is either spaced from the switch device or contacts it in such a way that the switch device is not actuated. This also applies to cases in which the switch device at least partially extends into the receptacle.

In the non-actuating shape, the actuating element may extend out of the receptacle to such an extent that actuation of a switch device located outside the receptacle occurs, or may be deformed in the receptacle to such an extent that actuation of a switch device at least partially protrudes into the receptacle occurs.

The actuating element comprises at least one elastically deformable material, such as rubber, silicone or other special plastics.

Embodiments with an actuating element are suitable, for example, for switch devices which have a first switching position (e.g., switched off/switched on) and can be brought into a second switching position (e.g., switched on/switched off) by means of the actuating element and automatically/automatically assume the first switching position when the actuating element no longer actuates the switch device or has again assumed the non-actuating shape. For this purpose, for example, pushbuttons or toggle/rocker switches are preloaded (e.g. by spring force) into a first position.

Furthermore, embodiments with two actuating elements are provided, in particular to actuate switch device which also have first and second switching positions, but which do not automatically/automatically assume the first switching position, but—as in the case of the second switching position SSt2—are to be brought into this position. Examples for this are toggle/rocker switches which are not preloaded in any of the switch positions (as they can be found for example as light switches in apartments).

In such embodiments it is intended to bring the switch device from the first switching position SSt1 to the second switching position by means of a first actuating element and from the second switching position SSt2 to the first switching position by means of a second actuating element.

The actuator may be in the form of, for example, a ring, ball or elongated member, each having an actuator cavity in which pressure can be pneumatically and/or hydraulically built up and removed to deform the actuator in a controlled manner, starting from the non-actuating shape into the actuating shape and back again, and to maintain the non-actuating shape and the actuating shape.

In addition or alternatively, a mounting cavity can be provided, which is located between an inner side of a mounting for an actuating element and an outer side of the actuating element. Pressure can be pneumatically and/or hydraulically built up and removed in the receptacle cavity to deform the actuator in a controlled manner from the non-actuating shape to the actuating shape and back again, and to maintain the non-actuating shape and the actuating shape.

Actuators with an actuator cavity may have a first actuator port through which pneumatic and/or hydraulic pressure can be supplied to the actuator cavity from a pressure generating source, for example through a line or hose. The first actuator port may also be used to remove/reduce pneumatic and/or hydraulic pressure in the actuator cavity of an actuator. Alternatively, a second actuator port can be provided for this purpose, which can, for example, controllably connect the actuator cavity with the ambient atmosphere/air.

In the case of a pick-up cavity, it may have a first pick-up port that allows pneumatic and/or hydraulic pressure from a pressure generating source to be supplied to the actuator cavity, for example, via a line or hose. The first port may also be used to remove/reduce dramatic and/or hydraulic pressure in the actuator cavity of an actuator. Alternatively, a second receptacle port can be provided for this purpose, which can, for example, controllably connect the actuator cavity with the ambient atmosphere/air.

The pressure generation source can be controlled by means of a control device for generating pneumatic and/or hydraulic pressure and delivering it to an actuator. In addition or alternatively, the first port may be controlled to selectively establish or interrupt a fluid connection between the pressure generating source and the actuator cavity of the actuator. In the case of a second port, it may be controlled to selectively establish or interrupt a fluid connection between the actuator cavity and the environment.

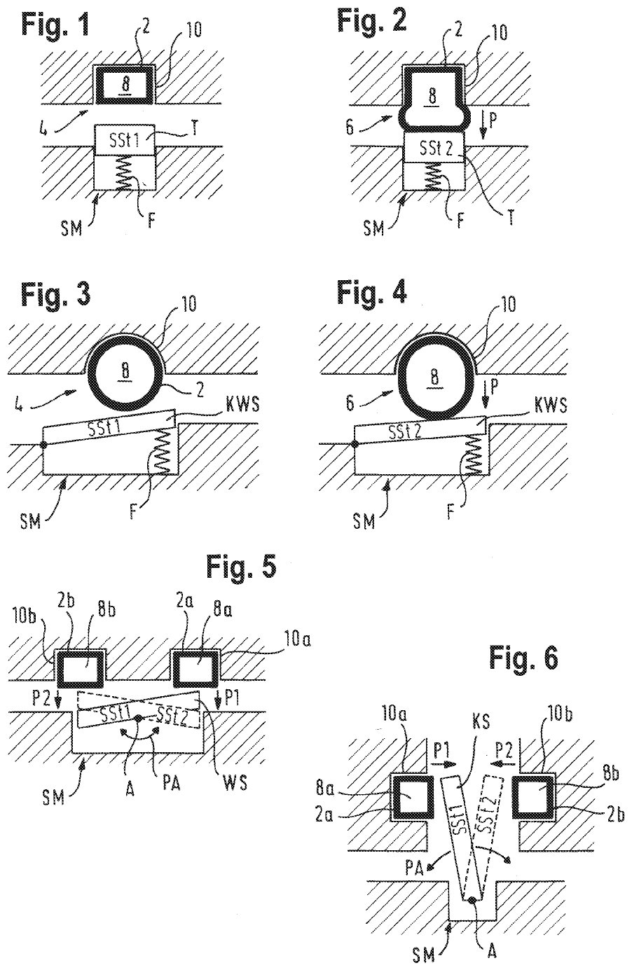

FIGS. 1 and 2 show cross-sectional views of an embodiment with an actuating element for actuating a switch device SM, here as an example a pushbutton T preloaded to a first switching position SSt1.

FIG. 1 shows the actuating element 2 in its non-actuating shape 4 and FIG. 2 shows the actuating element 2 in its actuating shape.

The actuating element 2 has an actuating element cavity 8.

The actuating element 2 in its non-actuating shape 4 has an essentially rectangular cross-section. In its non-actuating shape 4, the actuating element 2 can have an elongated shape (i.e. extend perpendicular to the drawing plane) or be ring-shaped (i.e. extend radially around a point in the drawing plane).

Actuator 2 is arranged in a receptacle and has a first actuator port, not shown here, which provides a fluid connection between the actuator cavity and a pressure generating source.

For example, the switch T is preloaded by a spring F into a first switching position SSt1 shown in FIG. 1 and can be moved into a second switching position SSt2 shown in FIG. 2 by a force acting downwards in the drawing plane. The latter represents an actuation of key T.

When the actuating element cavity 8 is pressurized via the first actuating element connection, the actuating element 2 deforms from the non-actuating shape 4 of FIG. 1 into the actuating shape of FIG. 2 and contacts the pushbutton T and acts on the pushbutton T with a force in the direction of the arrow P, which actuates the pushbutton T, i.e. moves it against the preload force into the first switching position SSt1.

If the pressure present in the actuator cavity 8 is completely released/removed via the first actuator port (or alternatively a second actuator port as described above) or at least to such an extent that the actuator 2 returns to its non-actuating shape 4 or the force of the actuator 2 acting on the button T is smaller than the force of the spring acting on the button T, the button T moves back to the first switching position SSt1.

FIGS. 3 and 4 show cross-sectional views of an embodiment with an actuating element 2 for actuating a switch device SM, here as an example a toggle/rocker switch KWS preloaded in a first switching position SSt1.

FIG. 3 shows the actuating element 2 in its non-actuating shape 4 and FIG. 4 shows the actuating element 2 in its actuating shape.

The actuating element 2 has an actuating element cavity 8.

The actuating element 2 in its non-actuating shape 4 has an essentially round cross-section. The actuating element 2 in its non-actuating shape 4 can have an elongated shape (i.e. extend perpendicular to the drawing plane) or be ring-shaped (i.e. extend radially around a point in the drawing plane).

The actuating element 2 is arranged in a receptacle 10 and has a first actuating element connection, not shown here, for a fluid connection between the actuating element cavity 8 and a pressure generation source.

The toggle/rocker switch KWS, for example, is preloaded by a spring F into a first switching position SSt1 shown in FIG. 3 and can be moved into a second switching position SSt2 shown in FIG. 4 by means of a force acting downwards in the drawing plane. The latter represents an actuation of the toggle/rocker switch KWS.

When the actuating element cavity 8 is pressurized via the first actuating element connection, the actuating element 2 deforms from the non-actuating shape 4 of FIG. 3 into the actuating shape of FIG. 4 and contacts the toggle/rocker switch KWS and acts with a force in the direction of the arrow P on the toggle/rocker switch KWS, which actuates it, i.e. moves it against the pretensioning force into the first switching position SSt2.

If the pressure present in the actuating element cavity 8 is completely released/removed via the first actuating element connection (or alternatively a second actuating element connection as described above) or at least to such an extent that the actuating element 2 returns to its nonactuating shape 4 or the force of the actuating element 2 acting on the toggle/rocker switch KWS is smaller than the force of the spring acting on the toggle/rocker switch KWS, the toggle/rocker switch KWS moves back to the first switch position SSt1.

FIG. 5 shows a cross-sectional view of an embodiment with two actuating elements 2a and 2b for actuating a switch device SM, here an example of a rocker switch WS which is not preloaded in any position.

FIG. 5 shows the actuating elements 2a and 2b in their non-actuating shapes 4.

The cross-sectional shapes of the actuating elements 2a and 2b are comparable to the actuating elements of FIG. 1, but can also have a different cross-sectional shape, for example that of FIG. 3.

The actuator 2a has an actuator cavity 8a and the actuator 2b has an actuator cavity 8b.

The actuating elements 2a and 2b are each arranged in a receptacle 10a and 10b and each have a first actuating element connection not shown here for a fluid connection between the respective actuating element cavity 8a or 8b and a pressure generation source.

The rocker switch WS can assume a first switching position SSt1 shown in FIG. 5 with a solid line and a second switching position SSt2 shown in FIG. 5 with a dotted line by swivelling around an axis A as indicated by arrow PA.

When pressure is applied to the actuator cavity 8a of the actuator 2a, the actuator 2a deforms from its non-actuating shape 4 to its actuating shape 6, as shown in FIG. 2, for example, contacts the rocker switch WS and acts with a force in the direction of the arrow P1 on the rocker switch WS, thereby actuating it, i.e. moving it to the second switching position SSt2.

Depending on the design of the rocker switch WS, it may be helpful to maintain the pressure in the actuating element cavity 8a of the actuating element 2a to keep the rocker switch WS in the second switching position SSt2. The same applies to the actuating element cavity 8b of actuating element 2b.

To return rocker switch WS from the second switch position SSt2 to the first switch position SSt1, pressure is applied to actuating element cavity 8b of actuating element 2b, causing actuating element 2b to change from its non-actuating shape 4 to its actuating shape 6 as shown in FIG. 2, is deformed, contacts the rocker switch WS and acts on the rocker switch WS with a force in the direction of the arrow P2, thereby actuating it, i.e. moving it to the first switching position SSt1. It may be necessary to reduce or remove the pressure in the actuating element cavity 8a of actuating element 2a before or at the same time as the pressure build-up in actuating element 8b of actuating element 2b.

FIG. 6 shows a cross-sectional view of an embodiment with two actuating elements 2a and 2b for actuating a switch device SM, here as an example a toggle switch KS not preloaded in any position.

FIG. 6 shows the actuating elements 2a and 2b in their non-actuating shapes.

The cross-sectional shapes of the actuating elements 2a and 2b are comparable to the actuating elements of FIG. 1, but can also have a different cross-sectional shape, for example that of FIG. 3.

The actuating elements 2a and 2b are each arranged in a receptacle 10a and 10b respectively and each have a first actuating element connection, not shown here, for a fluid connection between the respective actuating element cavity 8a or 8b and a pressure generation source.

The KS toggle switch can assume a first switch position SSt1 shown in FIG. 5 with a solid line and a first switch position SSt2 shown in FIG. 5 with a dotted line, by swivelling around an axis A as indicated by the arrow PA.

When pressure is applied to the actuator cavity 8a of the actuator 2a, the actuator 2a deforms from its non-actuating shape 4 to its actuating shape 6, as shown in FIG. 2, for example, contacts the toggle switch KS and acts on the toggle switch KS with a force in the direction of the arrow P1, thereby actuating the toggle switch KS, i.e. moving it to the first switch position SSt2.

Depending on the design of the KS toggle switch, it may be helpful to maintain the pressure in the actuating element cavity 8a of the actuating element 2a to keep the KS toggle switch in the second switching position SSt2.

To return toggle switch KS from the second switch position SSt2 to the first switch position SSt1, pressure is applied to actuator cavity 8b of actuator 2b, causing actuator 2a to deform from its non-actuating shape 4 to its actuating shape 6, as shown in FIG. 2, for example, and to contact toggle switch KS, and a force is applied to toggle switch KS in the direction of the arrow, thereby actuating it, i.e. moving it to the first switch position SSt1. It may be necessary to reduce or remove the pressure in the actuator cavity 8a of actuator 2a before or at the same time as the pressure build-up in the actuator cavity 8b of actuator 2b.

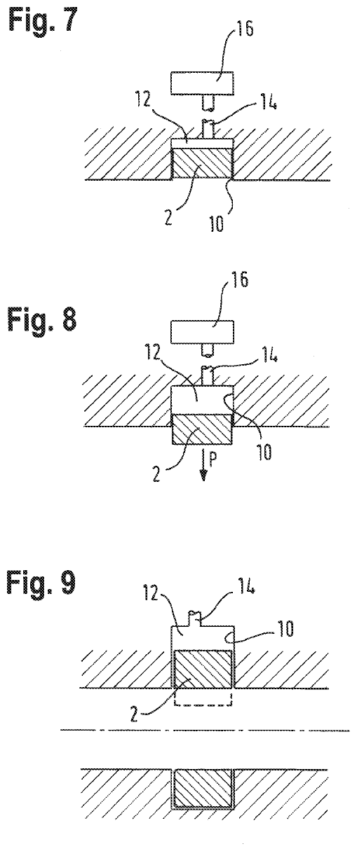

FIGS. 7 and 8 show cross-sectional views of an embodiment with an actuating element arranged in a receptacle 10 with a receptacle cavity 12. Alternatively, the actuating element can also have an actuating element cavity 8 as shown above.

The receptacle 10 has a receptacle connection 14 for a fluid connection between the receptacle cavity 12 and a pressure generation source 16.

The actuating element 2 in its non-actuating shape 4 has an essentially rectangular cross-section, but can also have a different cross-section, for example a round one. In its non-actuating shape 4, the actuating element of these embodiments can have an elongated shape (i.e. extend perpendicular to the drawing plane) and be fixed at its ends.

When the mounting cavity 12 is pressurized via the mounting connection 14, the actuating element 2 deforms from the non-actuating shape 4 of FIG. 7 into the actuating shape 6 of FIG. 8.

For the embodiments provided here, it may be helpful if the actuating element 2 is fastened at its ends and/or other areas (e.g. on inner walls of the mounting 10) so that actuating element 2 is not forced out of the mounting 10.

When the pressure in cavity 12 is released/removed via port 14 (or alternatively a second port as described above), the elasticity of actuator 2 may cause it to return to its non-actuating shape 4 when connected to an inner side of port 10.

FIG. 9 shows a cross-sectional view of an embodiment mold with an actuating element 2, which is arranged in a receptacle 10 with a receptacle cavity 12. Alternatively, the actuating element 2 can also have an actuating element cavity 8 as shown above.

The receptacle 10 has a receptacle connection for a fluid connection between the receptacle cavity 12 and a pressure generation source 16 (see e.g. FIGS. 7 and 8).

The actuating element 2 in its non-actuating shape 4 has an essentially rectangular cross-section, but can also have a different cross-section, for example a round one. The actuating element 2 in its non-actuating shape 4 can be ring-shaped (e.g. comparable to an O-ring).

The holder cavity 12 is only present in one area of the holder 10 as shown in the illustration, but can extend in a ring shape like the actuating element 2.

When the cavity 12 is pressurized via the first cavity connection, the actuating element 2 deforms from the shown non-actuating shape 4 into an actuating shape 6 indicated by dashed lines. Since the actuating element 2 is ring-shaped, it is not necessary to fasten it in the cavity 10.

When the pressure present in the pick-up cavity 12 is released/removed, the elasticity of the actuating element 2 reduces its non-actuating shape 4.

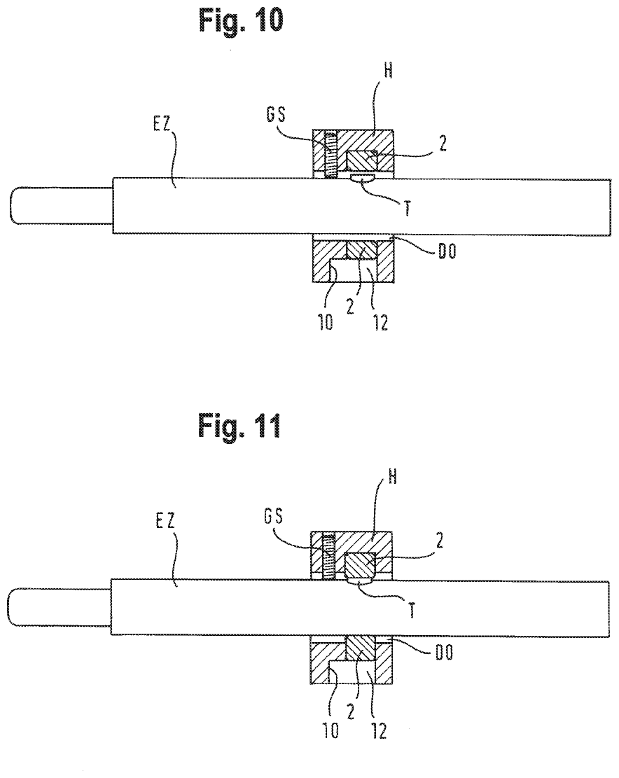

FIGS. 10 and 11 show schematic views of an embodiment for actuating a button T of an e-cigarette. This design comprises an essentially ring-shaped holder H with a through opening DO through which an e-cigarette EZ fits. The holder H has a means of securing the e-cigarette EZ in the holder H; as shown, a grub screw GS is provided for this purpose, which can be screwed in to secure the e-cigarette EZ and unscrewed to release it.

The holder H has a holder 10 for an actuating element 2 and a holder cavity 12. In this respect, the design of FIGS. 10 and 11 is comparable with the design of fixed point 9.

FIG. 10 shows the actuating element 2 in its non-actuating shape 4, whereby here the receiving cavity 12 is not pressurized or only pressurized in such a way that the actuating element 2 is not deformed or only deformed in such a way that a button T of the e-cigarette is not actuated.

FIG. 11 shows the actuating element 2 in its actuating shape 6, whereby here the receiving cavity 12 is pressurized so that the actuating element 2 is deformed so that the button T of the e-cigarette EZ is actuated.

1. An actuating device for a switch device, comprising:
an elastic actuating element with a non-actuating shape without actuation of the switch device and an actuating shape for actuating the switch device, and
at least one actuating element which is connected to the actuating element, which can be acted upon by means of pneumatic and/or hydraulic pressure in order to bring the actuating element from the non-actuating shape into the actuating shape.

2. The actuating device according to patent claim 1, in which:
the actuating element is arranged in a receptacle, and
the at least one cavity associated with the actuating element comprises a receiving cavity provided in the receptacle.

3. The actuating device according to claim 1, in which the at least one cavity associated with the actuating element comprises an actuating element cavity formed in the actuating element.

4. The actuating device according to claim 1, in which the actuating element is annular.

5. The actuating device according to claim 1, further comprising at least one fluid connection from the at least one cavity associated with the actuating element to a pressure generating source.

6. A method for actuating a switch device using an actuating device comprising an elastic actuating; element with a non-actuating shape without actuation of the switch device and an actuating shape for actuating the switch device,
and at least one actuating element which is connected to the actuating element, which can be acted upon by means of pneumatic and/or hydraulic pressure in order to bring the actuating element from the non-actuating shape into the actuating shape, the method comprising
applying pneumatic and/or hydraulic pressure to at least one cavity associated with the actuating element in order to bring the actuating element from the non-actuating shape to the actuating shape.

7. An e-cigarette push button actuator, comprising:
a holder and
an actuating device comprising an elastic actuating element with a non-actuating shape without actuation of the switch device and an actuating shape for actuating the switch device, and at least one actuating element which is connected to the actuating element, which can be acted upon by means of pneumatic and/or hydraulic pressure in order to bring the actuating element from the non-actuating shape into the actuating shape.
